(19) United States
(12) Patent Application Publication
(10) Pub. No.: US 2026/0229569 A1
(43) Pub. Date: Aug. 6, 2026

(54) Cost-efficient operation of a steel industry system and ad-ditional sub-systems of an entire system

(71) Applicant: Primetals Technologies Germany GmbH, Erlangen (DE)

(72) Inventors: Gerd BECKER, Marloffstein (DE); Klaus WEINZIERL, Nurnberg (DE); Gunther WINTER, Neunkirchen/Brand (DE)

(21) Appl. No.: 19/147,139

(22) PCT Filed: Dec. 14, 2023
(86) PCT No.: PCT/EP2023/085940

§ 371 Date: Jul. 10, 2025

(30) Foreign Application Priority Data
Jan. 11, 2023 (EP) 23151165.0
May 24, 2023 (EP) 23174988.8

(51) Int. Cl. H01M 8/0656; H01M 10/054

(52) U.S. Cl. CPC H01M 8/0656; H01M 10/054; H01M 2220/10; H01M 2250/10

(57) ABSTRACT

A system that includes as sub-systems, a steel industry system, an electrolysis system, an electric energy storage device, and a hydrogen storage device. The sub-systems are connected to transfer electric energy and hydrogen. A controller: a) sets operating modes for the sub-systems for a prognosis horizon; b) ascertains final sub-system states expected for the end of the prognosis horizon using a respective current state and a respective operating mode; c) varies the operating modes set for the prognosis horizon and the expected final states based thereon while taking into consideration a production plan and design limits of the sub-systems so that a cost function is minimized; d) operates the sub-systems according to the varied operating modes at least for the beginning of the prognosis horizon.

### TECHNICAL FIELD

The present invention is based on an operating method for an overall system,
wherein the overall system comprises, as subsystems, a steel industry installation, an electrolysis installation and an electrical energy storage device,
wherein the steel industry installation, the electrolysis installation and the electrical energy storage device are connected directly or indirectly to one another and to an electrical supply grid in order to transmit electrical energy.

The present invention is furthermore based on a control program for a control device for an overall system,
wherein the overall system comprises, as subsystems, a steel industry installation, an electrolysis installation and an electrical energy storage device,
wherein the steel industry installation, the electrolysis installation and the electrical energy storage device are connected directly or indirectly to one another and to an electrical supply grid in order to transmit electrical energy,
wherein the steel industry installation, the electrolysis installation and the hydrogen storage device are connected directly or indirectly to one another in order to transfer hydrogen,
wherein the control program comprises machine code able to be executed by the control device,
wherein the execution of the machine code by the control device causes the control device to control the overall system in line with such an operating method.

The present invention is furthermore based on a control device for an overall system,
wherein the overall system comprises, as subsystems, a steel industry installation, an electrolysis installation and an electrical energy storage device,
wherein the steel industry installation, the electrolysis installation and the electrical energy storage device are connected directly or indirectly to one another and to an electrical supply grid in order to transmit electrical energy,
wherein the steel industry installation, the electrolysis installation and the hydrogen storage device are connected directly or indirectly to one another in order to transfer hydrogen,
wherein the control device is programmed, by way of such a control program, such that the control device, when the machine code of the control program is executed, controls the overall system in line with such an operating method.

The present invention is furthermore based on an overall system,
wherein the overall system comprises, as subsystems, a steel industry installation, an electrolysis installation and an electrical energy storage device,
wherein the steel industry installation, the electrolysis installation and the electrical energy storage device are connected directly or indirectly to one another and to an electrical supply grid in order to transmit electrical energy,
wherein the steel industry installation, the electrolysis installation and the hydrogen storage device are connected directly or indirectly to one another in order to transfer hydrogen,
wherein the overall system comprises such a control device that, when the machine code of such a control program is executed, controls the overall system in line with such an operating method.

### PRIOR ART

The abovementioned subjects are known for example from the essay “Grüne Energieversorgung der Stahlindustrie” [Green Energy Supply for the Steel Industry], Stahl und Eisen [Steel and Iron], August 2022, pages 22 to 24.

KR 2019 0136300 A discloses an industrial process to which an energy storage device is assigned. The industrial process may be a more or less complex technical process that comprises multiple subprocesses that build on one another and interact with one another. The industrial process has various types of loads, namely loads that must be supplied with energy at all times, loads that are able to be switched off, and loads with a settable energy consumption. The actual energy consumption of the various components of the industrial installation is determined. The operation of the industrial installation and of the energy storage device are coordinated so as to achieve minimal costs.

U.S. Pat. No. 10,354,297 B2 discloses an arrangement comprising a domestic consumer, an energy generator and an energy storage device. The operation of the energy storage device may be ascertained taking into account a planned energy consumption of the consumer. Weather data may furthermore also be used in conjunction. It is also possible to take into account price information for drawing electrical energy from a supply grid and for feeding electrical energy into the supply grid.

TW 201 235 124 A discloses that the energy consumption of a steel industry installation—specific mention is made of a rolling mill—is able to be predicted with good accuracy when the operating mode of the steel industry installation is known.

U.S. Pat. No. 8,288,888 B2 discloses an electrolysis installation coupled to a wind farm. Other loads and other energy sources may additionally be present. The other loads and energy sources may also take the form of electrical energy storage devices. The hydrogen generated by the electrolysis installation may be transferred to an affiliated chemical plant or refinery.

U.S. Pat. No. 7,444,189 B1 discloses an operating method for an overall system that comprises, as components, an electrolysis installation, an electrical energy storage device, a hydrogen storage device and dwellings or small-scale business facilities. The electrolysis installation, the electrical energy storage device and the dwelling and the like are connected to one another and to an electrical supply grid in order to transmit electrical energy. Furthermore, the electrolysis installation, the hydrogen storage device and the dwelling and the like are connected to one another in order to transfer hydrogen. A control device is aware of current states of the electrolysis installation, of the energy storage device and of the hydrogen storage device. The control device is aware of the current electrical energy requirements of the other components of the overall system and, for a forecast horizon, of at least one expected price of electrical energy drawn from the supply grid. The control device sets operating modes for the subsystems for the forecast horizon and ascertains expected final states for the end of the forecast horizon. The operating modes comprise operating modes for the electrolysis installation, the electrical energy storage device and the hydrogen storage device. The expected final states comprise an expected final state ascertained by exploiting the corresponding current state and the corresponding set operating mode. For the forecast horizon, the control device varies the set operating modes and, based thereon, varies the associated expected final states, thereby minimizing a cost function. The cost function incorporates the costs of drawing electrical energy from the supply grid, the operating modes of the electrolysis installation, of the electrical energy storage device and of the hydrogen storage device, and assessments of the corresponding expected final states. At least for the beginning of the forecast horizon, the control device operates the electrolysis installation, the electrical energy storage device and the hydrogen storage device—but not the other parts of the overall system, in particular not the building or the like—in line with the corresponding varied operating mode.

### SUMMARY OF THE INVENTION

In the past when ascertaining the operation of steel industry installations, the costs incurred in the process—including the energy costs incurred in the process—were taken into account. However, they were taken into account only in the sense that the overall electrical energy demand and the resulting electrical energy costs were taken into account. In the course of the shift toward renewable energies, the availability of electrical energy (including the temporal fluctuations of the costs incurred for electrical energy) has to be taken into account to a considerably greater extent, since the availability and thus also the costs of electrical energy will be subject to considerably greater fluctuations in the future than they have been in the past.

The—expected—future power demand of the steel industry installation, on the one hand, and the—expected—future price of electrical energy drawn from the supply grid, on the other hand, are crucial for the efficient use of the electrical energy storage device and of the hydrogen storage device in the context of the present invention.

Although the abovementioned essay explains that the steel industry installation, the electrolysis installation and the electrical energy storage device are controlled and operated by a smart energy management system, it does not contain any more detailed explanations regarding the implementation of the smart energy management system.

The object of the present invention is to provide possibilities that achieve cost-efficient operation of an overall system that comprises, as subsystems, a steel industry installation, an electrolysis installation and an electrical energy storage device.

The object is achieved by an operating method having the features of claim 1. Dependent claims 2 to 7 relate to advantageous configurations of the operating method.

First of all, the overall system comprises, as a (further) subsystem, a hydrogen storage device—in addition to the abovementioned subsystems. Furthermore, the steel industry installation, the electrolysis installation and the hydrogen storage device are connected directly or indirectly to one another in order to transfer hydrogen. Furthermore, an operating method of the type mentioned at the outset is designed, according to the invention, in such a way that
a control device that controls the overall system is aware, as current states, of a current installation state of the steel industry installation, a current electrolysis state of the electrolysis installation, a current energy storage device state of the energy storage device and a current hydrogen storage device state of the hydrogen storage device,
the control device is aware, for a forecast horizon, of at least one desired production plan of the steel industry installation and at least one expected price of electrical energy drawn from the supply grid,
wherein the production plan of the steel industry installation defines which end products are intended to be produced from which starting materials by the steel industry installation and which characteristics the end products are intended to have,
the control device sets operating modes for the forecast horizon and ascertains expected final states for the end of the forecast horizon,
the operating modes comprise an installation operating mode for the steel industry installation, an electrolysis operating mode for the electrolysis installation, an energy storage device operating mode for the electrical energy storage device and a hydrogen storage device operating mode for the hydrogen storage device,
the expected final states comprise a final installation state ascertained by exploiting the current installation state and the set installation operating mode, an expected final electrolysis state ascertained by exploiting the current electrolysis state and the set electrolysis operating mode, an expected final energy storage device state ascertained by exploiting the current energy storage device state and the set energy storage device operating mode, and an expected final hydrogen storage device state ascertained by exploiting the current hydrogen storage device state and the set hydrogen storage device operating mode,
wherein the current and final installation state comprise which materials are in which state in each case in the steel industry installation and the state of units of the steel industry installation,
the control device varies the set operating modes and, based thereon, the expected final states for the forecast horizon, taking into account the production plan and design limits of the subsystems, so as to minimize a cost function,
the cost function incorporates the costs of drawing electrical energy from the supply grid, the operating modes of the steel industry installation, of the electrolysis installation, of the electrical energy storage device and of the hydrogen storage device, assessments of the expected final states and a productivity of the steel industry installation, and
the control device operates the subsystems in line with the varied operating mode, at least for the beginning of the forecast horizon.

The components of the steel industry installation accept input materials that they require to operate (possibly including energy media such as natural gas, for example). Depending on the circumstances, the input materials supplied may be iron ore for an iron-producing installation, liquid or solid iron or liquid or solid steel for an electric arc furnace, a converter or ladle installation, alloying elements and aggregates. Liquid steel is supplied to a continuous casting machine, and solid steel is supplied to a rolling mill and downstream devices.

The installation state of the steel industry installation describes the state of the steel industry installation to the required extent. The installation state comprises in particular which materials are in which state at the current time in the steel industry installation and the state of units of the steel industry installation.

In the case of an electric arc furnace, the expression “which materials are in which state at the current time in the steel industry installation” may comprise for example the quantity of metal in a furnace vessel of the electric arc furnace, its chemical composition, its temperature and phase composition (for example, solid proportion and molten proportion)—alternatively enthalpy—and progress in the production of the metal melt. In the case of an electric arc furnace, the expression “the state of units of the steel industry installation” may comprise for example the state of wear of the furnace vessel, a state of wear of electrodes of the electric arc furnace, a maximum possible power in principle and a maximum possible power at the current time. By way of example, the maximum possible power at the current time may be less than the maximum possible power in principle, because certain elements of the steel industry installation are not working or are working only partially. Similar statements apply in the case of a ladle furnace.

In the case of a rolling mill, the expression “which materials are in which state at the current time in the steel industry installation” may for example mean which material is currently being rolled and which materials are in a furnace upstream of the roll stands of the rolling mill at the current time, possibly including the sequence of the various materials. The materials may be characterized by their dimensions, their chemical composition and their temperature and phase composition (for example, ferrite proportion and austenite proportion and cementite proportion)—alternatively enthalpy. In the case of a rolling mill, the expression “the state of units of the steel industry installation” may for example comprise the state of wear of working rollers of roll stands of the rolling mill.

Similarly, the energy storage device state describes the state of the electrical energy storage device to the required extent. The energy storage device state may comprise for example the extent (in percentage and/or absolute terms) to which the energy storage device is charged and the temperature of storage cells of the energy storage device. Furthermore, the energy storage device state may also comprise the state of wear of the energy storage device or parts of the energy storage device. The energy storage device state may furthermore comprise maximum possible operating variables in principle and maximum possible operating variables at the current time, for example charging and discharge currents.

A current electrolysis state of the electrolysis installation may for example, provided there is a corresponding dependency of hydrogen production efficiency on power input, comprise a temperature of the electrolysis installation. The electrolysis state may also comprise other variables that may vary, for example concentrations of electrolytes.

A current hydrogen storage device state describes the state of the hydrogen storage device to the required extent. The hydrogen storage device state may in particular comprise a filling degree or fill level, that is to say the extent (in percentage and/or absolute terms) to which the hydrogen storage device is filled.

The production plan of the steel industry installation defines which end products are intended to be produced from which starting materials by the steel industry installation and which characteristics the end products are intended to have. The production plan may also define which intermediate products are intended to be produced. The production plan may furthermore define certain temporal constraints, for example when a specific product is to be produced by (“Product X should be ready by 6:00 p.m.”) or at what times or in what time ranges specific steps are intended to be performed in the manufacture of the respective end product or of the respective intermediate product and/or in what order the individual end products are intended to be manufactured. The production plan may also define which treatment steps are intended to be performed on the starting products or intermediate products by the steel industry installation. Finally, the production plan may also define planned downtimes of the steel industry installation or of parts of the steel industry installation. By way of example, a scheduled downtime may be required for maintenance purposes.

The expected price of electrical energy drawn from the supply grid may be defined in each case individually for different periods. On a spot market, the price is often fixed only for a relatively limited period, for example only 24 hours in advance. Here, specific quantities of power are traded for fixed periods at a respective spot market price. However, there are also contracts with longer-term commitments, for example a fixed price for a certain performance level for one year in advance. The two examples are of course not the only possible ones.

The billing of the actual power draw from the supply grid often also deviates from a previously agreed rate, if an amount of power different from that purchased beforehand is drawn. By way of example, although the power draw is purchased from the spot market on an hourly basis, billing is carried out on a quarter-hourly basis. If the amount of power purchased beforehand is drawn, the agreed rate will also be billed. If, on the other hand, more or less power is drawn than was purchased beforehand on the spot market, the actual price of electrical energy drawn from the supply grid depends on a number of factors. The actual price incorporates in particular whether and, where applicable, at what expense additionally drawn electrical energy had to be procured by the operator of the supply grid or whether and, where applicable, at what expense electrical energy that was purchased from the operator of the supply grid but not drawn was able to be utilized elsewhere. Such matters are outside the buyer's sphere of influence. It is therefore possible only to make reasonable estimates with regard to such matters. An exact prior calculation, on the other hand, is not possible.

Beyond periods for which the expected price of electrical energy drawn from the supply grid is known per se, it is also possible to make certain estimates based on empirical values.

In any case, there is the possibility of the expected price of electrical energy drawn from the supply grid not being a simple scalar, but rather a vector comprising multiple variables. Furthermore, there is always also the possibility of the price of electrical energy drawn from the supply grid not being a fixed, precisely defined value, but rather covering a certain price range.

All of these and, where applicable, other matters as well may be included in data for the price of electrical energy drawn from the supply grid. It is also possible for the data to determine the price only indirectly. One example of such data is a weather forecast, since the amount of sunshine (power generated by photovoltaic systems) and the amount of wind (power generated by wind turbines) have a direct influence on the amount of electrical energy that is generated and thus available, and consequently on the price of electrical energy drawn from the supply grid.

The installation operating mode for the steel industry installation is somewhat different from the production plan. In particular, the installation operating mode defines, for any time, how the steel industry installation is operated (=controlled). The installation operating mode is therefore continuous in terms of time (“the installation is operated in activation state A at 5:52:43 p.m., in activation state B at 5:52:44 p.m., in activation state C at 5:52:45 p.m.” etc.). The installation operating mode must of course be defined such that the specifications of the production plan are met.

The energy storage device operating mode for the electrical energy storage device defines the extent to which the electrical energy storage device is intended to be charged and discharged, respectively. The energy storage device operating mode is continuous, in the same way as the installation operating mode. An amount of electrical energy taken from the electrical energy storage device may possibly—of course only temporarily—even be so great that it exceeds the energy requirement of the steel industry installation and of the electrolysis installation, such that, as a result, electrical energy is fed into the supply grid.

The electrolysis operating mode for the electrolysis installation defines, for any time, how the electrolysis installation is operated (=controlled). The electrolysis operating mode is thus continuous in terms of time, in the same way as the installation operating mode. The electrolysis operating mode defines the extent to which power is required by the electrolysis installation and hydrogen is produced by the electrolysis installation.

The steel industry installation consumes hydrogen. The electrolysis installation produces hydrogen. If no further hydrogen generators and consumers are present other than the steel industry installation and the electrolysis installation, the hydrogen storage device operating mode for the hydrogen storage device is a dependent operating mode, because it simply has to receive or output the difference between the hydrogen required by the steel industry installation and the hydrogen produced by the electrolysis installation. When determining the installation operating mode and the electrolysis operating mode, it is only necessary to ensure that the hydrogen storage device does not become completely empty, has only a limited capacity and only certain amounts of hydrogen are able to be stored in or removed from the hydrogen storage device per unit of time.

The control device ascertains the expected final states for the end of the forecast horizon based on the current states by updating them according to the respective operating mode.

Varying the set operating modes with the objective of minimizing the cost function is a typical optimization problem. Optimization problems per se, the way in which optimization problems are addressed and the way in which optimization problems are solved are known to those skilled in the art. Reference may be made, purely by way of example, to
Fletcher, R.: Practical Methods on Optimization. 2^{nd} ed., John Wiley Inc., Chichester, New York 1987,
Hintermüller, M.; Stadler, G.: A semi-smooth Newton methods for linear-quadratic control problems, Zeitschrift für angewandte Mathematik und Mechanik (ZAMM) [Journal of Applied Mathematics and Mechanics]83-4, 219-237, (2003) or
Ito, K.; Kunisch, K.: Semi-smooth Newton methods for state-constrained optimal control problems, Systems and Control Letters, 50, 221-228, (2003).

It is also known from the abovementioned references how it is possible to formulate constraints to be complied with, for example performance limits of the steel industry installation and/or of the electrical energy storage device. Other matters relevant to the formulation of optimization problems are also known from the abovementioned references. One example of such matters is how deviations from preferred operating states are able to be “penalized”. Another example is how it is possible to formulate conditions to be complied with (through equality secondary constraints). Conditions to be complied with make it possible, for example, to force the state of subsystems of the overall system at the end of the forecast horizon. In the case of the electrical energy storage device, such a state may be for example its state of charge and, in the case of a hydrogen storage device, such a state may be for example its stored amount of hydrogen.

The term “cost function” has a clear-cut meaning for a person skilled in the art in the field of optimization problems. Although it may be understood in the sense of an economic assessment, this is not necessarily the case. In this case, the cost function may incorporate various variables.

The cost function incorporates the costs of drawing electrical energy from the supply grid. The costs of drawing electrical energy are self-explanatory. It is pointed out merely that the costs may be negative in individual cases, namely when electrical energy is fed back into the supply grid from the electrical energy storage device or when the price of drawing electrical energy becomes negative for a time, for example due to a temporary oversupply.

The cost function furthermore incorporates the operating modes of the various subsystems and assessments of the expected final states. The assessment of the expected final installation state may comprise wear-induced costs of the steel industry installation. The assessment of the expected final installation state may furthermore comprise a proportion that is ascertained for example by exploiting an energy state or a phase state of products located in the steel industry installation. A similar assessment is possible for the electrolysis installation. With regard to the two storage devices, the assessment may in particular incorporate a wear. The assessment of the expected final states of the storage devices may furthermore comprise a proportion that is ascertained by exploiting a degradation of the respective storage device brought about by the respective storage device operating mode, that is to say a deterioration of the performance of the respective storage device.

The cost function furthermore incorporates a productivity of the steel industry installation.

The steel industry installation preferably has at least one component technologically upstream of a casting device used to cast liquid steel.

The casting device may in particular be designed as a continuous casting installation. The upstream component may be a component that produces liquid steel (for example an electric arc furnace or a converter) or performs refining (for example a ladle installation). As an alternative, the upstream component may be an iron production installation, for example a DRI installation. In this case, the iron produced by this component is supplied to an electric arc furnace. Of course, the steel industry installation may also comprise other components, in particular components for producing or processing solid steel. Such components may be for example a continuous casting machine, a rolling mill (hot and/or cold) and other components, for example a reel or a pickling line.

In some cases, the overall system has, as a further subsystem, a power generation device by way of which electrical energy is able to be generated renewably. In this case, the power generation device is connected directly or indirectly to the steel industry installation, the electrolysis installation and the electrical energy storage device and the electrical supply grid in order to transmit electrical energy.

The power generation device may be designed in particular as a wind turbine or as a photovoltaic installation. The operating method is designed, in the case of an existing power generation device, in such a way that
the control device, for the forecast horizon, is additionally aware of an expected electrical energy able to be generated by the power generation device, and
the control device takes into account the expected electrical energy able to be generated by the power generation device when varying the operating modes.

This enables even further optimization of the operation of the overall system.

As already mentioned, in the event that hydrogen is able to be transferred only between the electrolysis installation, the hydrogen storage device and the steel industry installation, the hydrogen storage device operating mode is a dependent or derived operating mode that results entirely from the hydrogen requirement of the steel industry installation and the generation of hydrogen by the electrolysis installation. However, in some cases, the overall system has, as a further subsystem, a coupling device that is connected directly or indirectly to the steel industry installation and/or the electrolysis installation and/or the hydrogen storage device, on the one hand, and is connected to an external hydrogen transport network or to an additional hydrogen storage device, which is connected detachably to the coupling device, on the other hand, in order to transfer hydrogen. In this case, the control device takes into account the hydrogen transferred via the coupling device when varying the operating modes. In such cases, the hydrogen storage device operating mode is an operating mode that is able to be set, varied and thus ascertained as an independent variable that is able to be varied separately. In this case, the operation of the coupling device results as a dependent operating mode. As an alternative, the operation of the coupling device could also be set as an independent operating mode that is able to be varied separately, and the hydrogen storage device operating mode could be maintained as a dependent operating mode.

Non-negligible losses arise when storing hydrogen for relatively long periods. Depending on the type of storage, the loss rate is at least 0.1% of the stored amount of hydrogen per day, and may be up to 0.5% per day. For this reason, the cost function should preferably also incorporate losses of hydrogen contained in the hydrogen storage device.

Preferably, the control device takes into account a minimum and maximum state of charge of the electrical energy storage device and/or an average state of charge of the electrical energy storage device and/or a minimum and maximum fill level of the hydrogen storage device and/or an average fill level of the hydrogen storage device when varying the operating modes. Taking such variables into account—whether as constraints to be observed or by incorporating them directly into the cost function—makes it possible to achieve a situation whereby the electrical energy storage device and/or the hydrogen storage device have a certain capacity at all times and in both directions—both for receiving electrical energy or hydrogen and for outputting electrical energy or hydrogen, such that it is possible to respond to malfunctions during the operation of the steel industry installation and/or the electrolysis installation—where applicable even in the event of malfunctions in the supply grid, the power generation device and/or the supply device—by way of changed operating modes of the electrical energy storage device and/or of the hydrogen storage device.

Preferably, the electrical energy storage device comprises a first partial storage device and a second partial storage device, both of which are connected to the electrical supply grid. In this case, the current energy storage device state comprises a respective current substate for the first and second partial storage device, the energy storage device operating mode comprises a respective sub-operating mode for the first and second partial storage device, and the expected final energy storage device state comprises a respective expected final substate for the first and second partial storage device. Furthermore, in this case, when varying the energy storage device operating mode, the two sub-operating modes are varied and the two expected final substates are varied based thereon. In this case, the control device operates the first and second partial storage device in line with the respective varied sub-operating mode, at least for the beginning of the forecast horizon.

The two partial storage devices thus constitute two different electrical energy storage devices the operating modes of which are both varied in order, as an overall result, to minimize the costs of operating the overall system. It is thus possible, for each of the two partial storage devices, to take the same measures that are taken for the electrical energy storage device in the case of a single electrical energy storage device.

This procedure is particularly advantageous if the first and second partial storage device differ in terms of their possible performance limits, for example in terms of their capacity and their maximum possible or permissible charging and discharge current (or a corresponding power). By way of example, the first partial storage device may have a high storage capacity and a relatively low maximum charging and discharge power, while the second partial storage device may have a significantly lower storage capacity, but a significantly higher maximum charging and discharge power. Mention may be made of exemplary values of 100 MWh and 25 MW for the first partial storage device and 10 MWh and 100 MW for the second partial storage device. The first partial storage device may for example be in the form of a redox-flow battery or a sodium-sulfur battery, and the second partial storage device may be in the form of a sodium-ion battery.

However, the provision of two partial storage devices may also be advantageous if the partial storage devices are of identical structure and design. This may be the case for example if an (almost) on-the-fly replacement of an energy storage device is intended to be carried out. In this case, during normal operation, only a single electrical energy storage device is present (that is to say without subdivision into first and second partial storage devices). However, if the electrical energy storage device gradually reaches the end of its service life, that is to say has to be replaced, a further electrical energy storage device may first be added to the overall system at a time A, such that the overall system, from the time A, has two electrical energy storage devices, that is to say a first and second partial storage device in the sense of the above explanations. At a later time B, the energy storage device, which gradually reaches the end of its service life, is then removed from the overall system. From the time B, the overall system again has only a single electrical energy storage device, namely the energy storage device that was added to the overall system at the time A. Normal operation is thus resumed. Between the times A and B, however, there is temporarily a special operating mode in which not just one electrical energy storage device is present, but rather two electrical energy storage devices or—in the above terminology—the electrical energy storage device comprises a first and second partial storage device.

The provision of two partial storage devices may furthermore also be advantageous if the partial storage devices are of identical structure and design, but have different states of ageing or wear.

The division, explained above, into two partial storage devices may of course also be expanded to three, four etc. partial storage devices.

The object is furthermore achieved by a control program having the features of claim 8. According to the invention, the controlled overall system comprises, as a (further) subsystem, a hydrogen storage device—in addition to the abovementioned subsystems. Furthermore, the steel industry installation, the electrolysis installation and the hydrogen storage device are connected directly or indirectly to one another in order to transfer hydrogen. Furthermore, the execution of the machine code by the control device causes the control device to control the overall system in line with an operating method according to the invention.

The object is furthermore achieved by a control device having the features of claim 9. According to the invention, the controlled overall system comprises, as a (further) subsystem, a hydrogen storage device—in addition to the abovementioned subsystems. Furthermore, the steel industry installation, the electrolysis installation and the hydrogen storage device are connected directly or indirectly to one another in order to transfer hydrogen. Furthermore, the control device is programmed, by way of a control program according to the invention, such that the control device, when the machine code of the control program is executed, controls the overall system in line with an operating method according to the invention.

The object is furthermore achieved by an overall system having the features of claim 10. According to the invention, provision is made
that the controlled overall system comprises, as a (further) subsystem, a hydrogen storage device—in addition to the abovementioned subsystems,
that the steel industry installation, the electrolysis installation and the hydrogen storage device are connected directly or indirectly to one another in order to transfer hydrogen, and
that the control device is designed as a control device according to the invention, which, when the machine code of the control program is executed, controls the overall system in line with an operating method according to the invention.

### BRIEF DESCRIPTION OF THE FIGURES

The above-described properties, features and advantages of this invention, and the manner in which these are achieved, will become clearer and more clearly comprehensible in conjunction with the following description of one exemplary embodiment, which is explained in more detail in conjunction with the drawings. In the figures:

FIG. 1 shows an overall system,

FIG. 2 shows a flowchart,

FIG. 3 shows a further overall system,

FIG. 4 shows a further flowchart,

FIG. 5 shows a steel industry installation and

FIG. 6 shows an electrical energy storage device and a supply grid.

### DESCRIPTION OF THE EMBODIMENTS

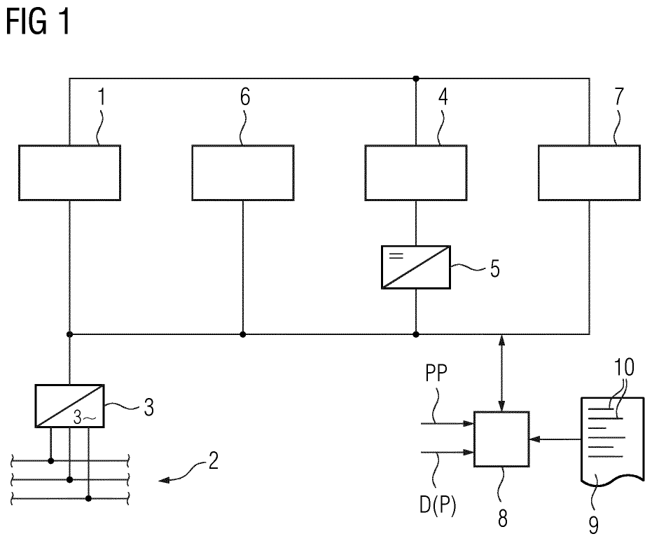

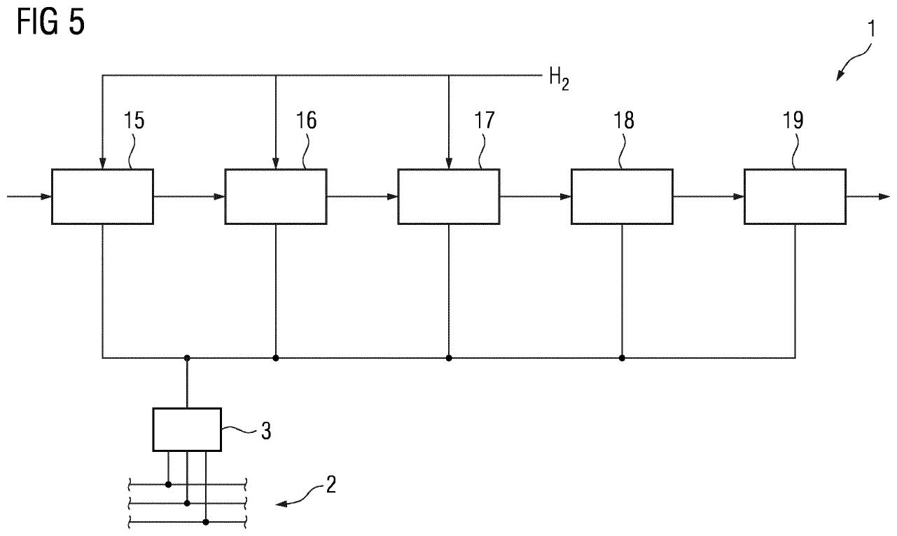

In accordance with FIG. 1, an overall system comprises a steel industry installation 1 as a subsystem. One possible embodiment of the installation 1 will be explained in more detail later in conjunction with FIG. 5. The installation 1 may have multiple components. Generally speaking, the installation 1 has at least one component technologically upstream of a casting device used to cast liquid steel. Examples of such components are an iron-producing component (for example a DRI installation), an electric arc furnace, a converter and a ladle installation.

The installation 1 consumes electrical energy during operation thereof. The installation 1 may draw the electrical energy from an electrical supply grid 2 to which the installation 1 is connected directly (not illustrated) or indirectly (for example via a power converter 3). The supply grid 2 is typically a three-phase grid and thus a multi-phase supply grid. The three-phase grid is often operated with a medium voltage in the range from 20 kV to 30 kV or with a high voltage of 110 kV.

The overall system comprises an electrolysis installation 4 as a further subsystem. The electrolysis installation 4 also consumes electrical energy during operation thereof. The electrolysis installation 4 is therefore likewise connected to the supply grid 2. The electrolysis installation 4 requires a DC voltage to operate. A rectifier 5 is therefore usually arranged upstream of the electrolysis installation 4, and so there is only an indirect connection to the supply grid 2.

The overall system comprises an electrical energy storage device 6 as a further subsystem. The energy storage device 6 is connected directly or indirectly to the supply grid 2 at least in order to receive electrical energy, possibly also in order to output electrical energy. The energy storage device 6 is furthermore connected to the installation 1 and to the electrolysis installation 4 in order to output electrical energy. If the energy storage device 6 receives electrical energy, this is always drawn from the supply grid 2. If the energy storage device 6 outputs electrical energy, this is used primarily to cover the requirements of the installation 1 and of the electrolysis installation 4 and only secondarily to feed into the supply grid 2. As a result—depending on whether the electrical energy output by the energy storage device 6 is greater or less than the electrical energy consumed by the installation 1 and electrolysis installation 4—electrical energy may thus temporarily be fed into the supply grid 2 or drawn from the supply grid 2.

It must be possible to set whether, and to what extent, electrical energy is supplied to the energy storage device 6 or whether, and to what extent, the electrical energy storage device 6 outputs electrical energy. For this purpose, a bidirectionally operable power converter unit is generally present. This power converter unit is not also illustrated in FIG. 1. Rather, it is considered to be part of the energy storage device 6.

The exact way in which the installation 1, the electrolysis installation 4 and the energy storage device 6 are electrically connected to one another and to the supply grid 2 is of lesser importance. In particular, rectifiers 5, inverters and other power converters 3 may be assigned to the various subsystems 1, 4 and 6, as required. However, it should be ensured that it is possible to transfer electrical energy from the energy storage device 6 to the installation 1 and the electrolysis installation 4 without a diversion via the supply grid 2.

The installation 1 furthermore also requires hydrogen to operate. The installation 1 and the electrolysis installation 4 are therefore connected directly or indirectly to one another in order to transfer hydrogen. Any pumps, valves and the like are not also illustrated in FIG. 1.

The overall system comprises a hydrogen storage device 7 as a further subsystem. The hydrogen storage device 7 may be designed as a storage device in a narrower sense, that is to say as a dedicated hydrogen storage device. However, the pipeline network via which hydrogen is transported also has a certain storage capacity and may serve as a hydrogen storage device 7 for the purposes of the present invention. In the case of a separate dedicated storage device, the storage device may alternatively be arranged overground or underground. The hydrogen storage device 7 is connected directly or indirectly to the electrolysis installation 4 in order to receive hydrogen and connected directly or indirectly to the installation 1 in order to output hydrogen. The operation of the installation 1 and of the electrolysis installation 4 is able to be made more flexible due to the hydrogen storage device 7.

It is possible for the hydrogen generated by the electrolysis installation 4 always to be supplied to the hydrogen storage device 7 and for the hydrogen required by the installation 1 always to be supplied by the hydrogen storage device 7, such that the hydrogen storage device 7 serves as a hydrogen transfer station, as it were. However, a direct connection between the installation 1 and the electrolysis installation 4 is also possible.

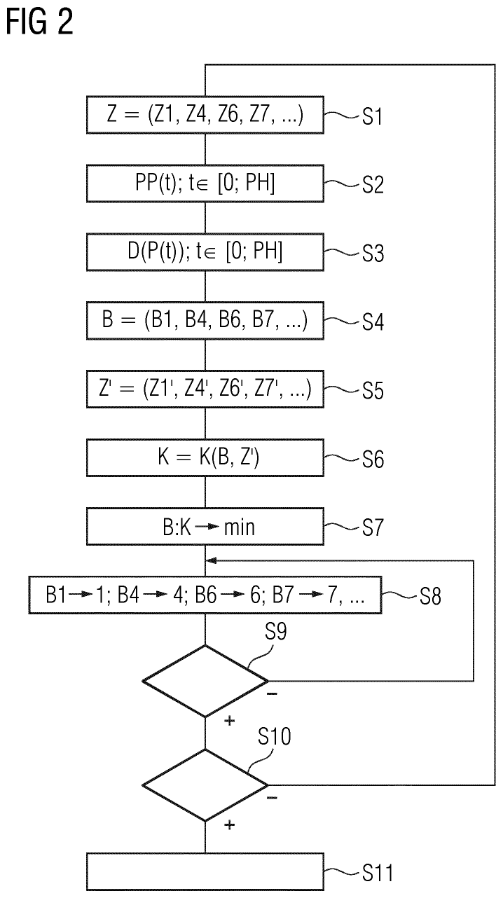

The overall system furthermore comprises a control device 8. The control device 8 is programmed with a control program 9. The control program 9 comprises machine code 10 able to be executed by the control device 8. The programming with the control program 9 causes the control device 8 to execute the machine code 10. The execution of the machine code 10 by the control device 8 causes the control device 8 to control the overall system in line with an operating method that is explained in more detail below in conjunction with FIG. 2. However, even before the operating method according to the invention is explained, it is pointed out that the control device 8 is explained below as being a uniform control device 8 that jointly controls the subsystems 1, 4, 6 and 7 of the overall system. However, the control device 8 may likewise have its own sub-control device for controlling each of the subsystems 1, 4, 6 and 7. In this case, appropriate information exchange and coordination must take place between the sub-control devices.

In accordance with FIG. 2, in a step S1, the control device 8 is made aware of a current state Z of the overall system. The current state Z comprises a respective current substate Z1, Z4, Z6, Z7 for the subsystems 1, 4, 6 and 7. The number in the respective current substate Z1, Z4, Z6, Z7 corresponds to the reference sign of the respective subsystem 1, 4, 6 and 7.

By way of example, substate Z1—assuming that corresponding components of the installation 1 are present—may comprise the following variables:
the production progress of an iron-producing installation,
the production progress of an electric arc furnace,
a process state of a continuous casting machine,
a temperature of a furnace upstream of a rolling mill,
states of wear of working rollers of roll stands of the rolling mill,
whether rolling passes are currently being carried out in the roll stands of the rolling mill.

Substate Z1 furthermore comprises which materials are in which state at the current time in the installation 1. By way of example, substate Z1—assuming that corresponding materials are present in corresponding components of the installation 1—may comprise the following variables:
quantity and state of a batch in an electric arc furnace or in a ladle,
durations for which rolling stock has already been in a furnace,
temperatures of the rolling stock.

Substate Z4 may comprise for example a temperature and a chemical composition of the electrolysis fluid of the electrolysis installation 4 and a state of wear of the electrolysis installation 4.

Substate Z6 comprises at least the state of charge of the energy storage device 6, that is to say the extent to which the energy storage device 6 is charged. Substate Z6 may also comprise other variables, for example a temperature of the energy storage device 6 or a maximum possible or permissible charging and discharge current. Furthermore, substate Z6 may comprise a state of wear of the energy storage device 6.

Similarly, substate Z7 comprises at least the fill level of the hydrogen storage device 7, that is to say the extent to which the hydrogen storage device 7 is filled. Substate Z7 may also comprise other variables, for example a temperature and/or a gas pressure of the hydrogen storage device 7 or a maximum possible or permissible flow of a hydrogen flow when filling and emptying the hydrogen storage device 7.

In a step S2, the control device 8 is made aware of a desired production plan PP of the installation 1. By way of example, the production plan PP may be specified to the control device 8 by an operator (not illustrated). The production plan PP defines which end products are intended to be produced from which starting materials by the installation 1 and which characteristics the end products are intended to have. Generally speaking, the production plan PP also defines which intermediate products are to be produced and by when a specific product is supposed to be produced. The production plan PP extends over a forecast horizon PH. The forecast horizon PH is generally at least several hours, often even in the range of several days.

By way of example, the production plan PP—assuming that corresponding components of the installation 1 are present—may comprise the following variables:
a quantity of pig iron that is intended to be produced per hour or per day by a DRI (direct reduction of iron) installation;
quantities, chemical compositions and temperatures and completion times for molten metals produced using an electric arc furnace,
casting format and casting speed of a continuous casting installation, and quantities and grades of steel to be cast;
times when rolling stock is to be supplied to a rolling mill and the intended temperatures of the rolling stock at these times,
pass plans for rolling stock supplied to the rolling mill;
desired geometric characteristics (for example thickness, width, profile, contour, flatness) and material characteristics (for example material strength, yield strength) of rolling stock after rolling in the rolling mill.

In a step S3, the control device 8 is made aware of data D that are used to determine at least one expected price P of electrical energy for the forecast horizon PH, if the electrical energy is drawn from the supply grid 2. The expected price P is defined at least as a function of time t. It may also depend on other circumstances, for example the amount of active power drawn, the reactive power drawn, the proportion of harmonics in the electrical energy drawn, and the proportion of asymmetries between the various phases of the supply grid 2. In particular, peak load power is expensive, reactive power loads the supply grid 2 without contributing to active power, and harmonics and asymmetries may cause disturbances in other consumers and may also be perceived as being unpleasant by people (keyword “flicker”). Electrical energy fed back into the supply grid 2 is also often remunerated differently than electrical energy drawn from the supply grid 2.

If necessary, the control device 8 may initially be made aware of the production plan PP and the data D for the price P for different time horizons in steps S2 and S3. In this case, the forecast horizon PH is determined by the smaller of the two time horizons.

In a step S4, the control device 8 sets an operating mode B for the overall system for the forecast horizon PH. Operating mode B comprises—in the same way as the current state Z—a respective sub-operating mode B1, B4, B6, B7 for the subsystems 1, 4, 6 and 7. The sub-operating modes B1, B4, B6, B7 define, for any time, how the respective subsystem 1, 4, 6, 7 is operated (=controlled). The sub-operating modes B1, B4, B6, B7 may be time-resolved to the second. The set operating modes B, B1, B4, B6, B7 are initially only provisional.

Sub-operating mode B1 for the installation 1—hereinafter also referred to as installation operating mode B1—is defined by the control device 8 such that the specifications of the production plan PP are met. Depending on the design of the installation 1 or its components, installation operating mode B1 may for example comprise:
the quantities of materials and energy supplied to a DRI installation, for example the quantity of iron ore, the amount of hydrogen and the amount of electricity;
the quantities of materials and energy supplied to an electric arc furnace, for example the quantity of pig iron, aggregates, alloying elements, electrical energy, hydrogen and other process media;
the extraction rate at which a cast metal strand is extracted from a continuous mold, the amplitude and frequency of a mold oscillation, the extent of primary cooling and secondary cooling, and the quantity of casting powder supplied (the quantity of metal to be supplied is determined by the casting format and the extraction rate);
rolling speeds and adjustments of roll stands of a rolling mill and settings of cooling devices of a cooling section downstream of the rolling mill.

Sub-operating mode B4 for the electrolysis installation 4—hereinafter also referred to as electrolysis operating mode B4—may often be defined separately and relatively flexibly by the control device 8. The control device 8 only has to ensure that the hydrogen requirement of the installation 1 is covered, the filling degree of the hydrogen storage device 7 does not fall below 0% and does not rise above 100% and also that the design limits of the electrolysis installation 4 are observed. As an alternative to a practically free approach for electrolysis operating mode B4, it is also possible to specify, for the electrolysis installation 4 as well, a production plan that must be taken into account when ascertaining electrolysis operating mode B4. As the individual case may be, more or less uniform operation of the electrolysis installation 4 may make sense. However, it may also make sense to vary the operation of the electrolysis installation 4 over time, in particular if electrical energy costs fluctuate greatly.

Sub-operating mode B6 for the energy storage device 6—hereinafter also referred to as energy storage device operating mode B6—may likewise often be defined separately and relatively flexibly by the control device 8. The control device 8 only has to ensure that the state of charge of the energy storage device 6 does not fall below 0% and does not rise above 100% and also that the design limits of the energy storage device 6 (for example the maximum charging current and the maximum discharge current) are observed.

Sub-operating mode B7 for the hydrogen storage device 7—hereinafter also referred to as hydrogen storage device operating mode B7—is usually no longer able to be defined freely by the control device 8. Rather, it is defined by installation operating mode B1 (and thus the consumption of hydrogen) and electrolysis operating mode B4 (and thus the generation of hydrogen). The hydrogen storage device 7 makes it possible, at least to a certain extent, to decouple the operation of the installation 1 and of the electrolysis installation 4 from one another, and thus enables flexible operation of the electrolysis installation 4.

In a step S5, the control device ascertains an expected final overall state Z′ for the end of the forecast horizon PH. The expected final overall state Z′ comprises—in the same way as the current state Z—an expected final substate Z1′, Z4′, Z6′, Z7′ for each of the subsystems 1, 4, 6 and 7. The respective expected final substate Z1′, Z4′, Z6′, Z7′ is ascertained by exploiting the respective current substate Z1, Z4, Z6, Z7 and the respective sub-operating mode B1, B4, B6, B7. Specifically, the control device 8 ascertains the respective expected final substate Z1′, Z4′, Z6′, Z7′ by updating the respective current substate Z1, Z4, Z6, Z7 based on the respective sub-operating mode B1, B4, B6, B7.

In a step S6, the control device 8 ascertains the value of a cost function K. The cost function K incorporates various cost factors. The cost function K is defined as a weighted or unweighted sum of the individual cost factors. Cost factors to be considered include, for example, the costs of drawing electrical energy from the supply grid 2, operating modes B1, B4, B6, B7 of the subsystems 1, 4, 6, 7, assessments of the expected final states Z1′, Z4′, Z6′, Z7′ and a productivity of the steel industry installation.

To ascertain the costs of drawing electrical energy from the supply grid 2, the control device 8 may for example ascertain the drawing of electrical energy from the supply grid 2 based on the ascertained sub-operating modes B1, B4, B6, B7 and ascertain, based thereon, in conjunction with the known price P, the associated costs. The ascertainment may take place with the same temporal resolution with which sub-operating modes B1, B4, B6, B7 are also determined, for example to the second. The ascertainment may also take place with a coarser temporal resolution, for example with a resolution of 1 minutes or 15 minutes. It is also possible to initially work with a high temporal resolution, for example to the second, but, based thereon, to carry out statistical evaluations for longer periods (for example 1 minute, 5 minutes, 15 minutes), for example to ascertain averages, maximum values, minimum values, scatter, etc.

Installation operating mode B1 may be assessed for example in terms of productivity, resource-saving operation, an assessment of the wear of the installation 1, etc. Similar assessments are also possible for electrolysis operating mode B4, energy storage device operating mode B6 and hydrogen storage device operating mode B7.

The assessment of the expected final installation state Z1′ may comprise a proportion that is ascertained for example by exploiting an energy state of the installation 1—this also comprises the energy state of products located in the installation 1. The control device 8 is thereby capable of ascertaining the assessment of the expected final installation state Z1′ taking into account an amount of energy that needs to be applied during subsequent operation of the installation 1 beyond the forecast horizon PH.

In the case of an electric arc furnace or a ladle, for example, the temperature of the melt in the electric arc furnace or the ladle may be taken into account. In the case of an electric arc furnace, it is furthermore possible for example to take into account the fact that, although a time window is available for the production of a melt that is greater than the minimum time required to produce the melt, it may be the case that disproportionately more energy is required later in order to heat the melt to its target temperature, due to the way in which heating is carried out.

In the case of a hot strip mill, for example, it may be taken into account that slabs in a slab furnace are not yet fully heated, that is to say a certain amount of energy will also be required later for complete heating (=after the forecast horizon PH has expired). It may also be taken into account that slabs are supplied later to a rolling mill at a lower temperature due to incomplete heating in the slab furnace. The lower temperature means that higher rolling forces and rolling torques, and therefore a higher energy requirement, are necessary during rolling. The wear of the working rollers of the roll stands of the rolling mill and the resulting costs may also be greater in such a case.

The assessment of the expected final installation state Z1′ may also take into account the wear caused by the operation of the installation 1, that is to say the costs resulting from wear that occurs during the production horizon PH due to installation operating mode B1.

The assessment of the expected final electrolysis state Z4′ may likewise comprise a proportion that is ascertained by exploiting an energy state of electrolysis installation 4, in particular in the case of an electrolysis installation 4 that operates at a high temperature. The assessment may also incorporate concentrations of electrolyte fluids and states of wear.

The assessment of the expected final energy storage device state Z6′ may comprise a proportion to which the wear caused by the operation of the energy storage device 6 is taken into account, that is to say the costs resulting from wear that occurs during the production horizon PH due to the storage device operating mode B6.

The assessment of the expected final hydrogen storage device state Z7′ is usually very simple. It is usually just a constant.

The assessment of the productivity of the installation 1 is usually likewise relatively simple. It is usually better (that is to say the corresponding cost factor is smaller) the greater the quantity of starting product produced in a given unit of time. In the simplest case, the corresponding cost factor is proportional to the time needed to produce a quantity, defined beforehand on a one-off basis, of starting product.

The cost function K may also incorporate yet further cost factors. A few possible further cost factors will be discussed below by way of example.

By way of example, it is possible to take into account a cost factor that represents the costs of the remainder of the operation of the installation 1, that is to say the costs that result for the forecast horizon PH in question, but without taking into account the costs of the electrical energy. The costs of the remainder of the operation of the installation 1 may for example comprise the costs of required input materials such as starting materials and process media, or the costs of the preparation of process media or costs due to environmental pollution. The cost factor for the remainder of the operation of the installation 1 may furthermore comprise depreciation.

Similarly, it is also possible to take into account cost factors that represent the costs of the remainder of the operation of the electrolysis installation 4, of the energy storage device 6 and of the hydrogen storage device 7. Losses of hydrogen contained in the hydrogen storage device 7 may in particular also be taken into account for the cost factor for the hydrogen storage device 7.

Other costs of the overall system may furthermore also be taken into account if such costs are incurred. Examples of such costs are environmental levies or state subsidies.

As a result, the cost function K thus incorporates all free control variables for all subsystems 1, 4, 6, 7.

In a step S7, the control device 8 solves an optimization problem. The solution to the optimization problem is the combination of those sub-operating modes B1, B4, B6, B7—each considered over the production horizon PH—for which the cost function K as a whole is minimal. The cost function K is thus a functional that is to be minimized and is calculated on the basis of an initial value problem with end conditions. As part of solving the optimization problem, the control device 8 varies the set sub-operating modes B1, B4, B6, B7 for the forecast horizon PH. The variation is carried out taking into account the production plan PP and other constraints, such as for example design limits of the various subsystems 1, 4, 6, 7. Taking the production plan PP into account means that the production plan PP is complied with. If specified, a production plan of the electrolysis installation 4 is also taken into account as well.

Preferably, the control device 8, when varying the sub-operating modes B1, B4, B6, B7, furthermore takes into account a minimum and maximum state of charge of the electrical energy storage device 6.

This may be taken into account in particular using what are known as inequality secondary constraints, in which there is a requirement for the state of charge of the electrical energy storage device 6 never to become less than the minimum state of charge and never to become greater than the maximum state of charge. Likewise, the control device 8, when varying the sub-operating modes B1, B4, B6, B7, preferably also takes into account a minimum and maximum filling degree of the hydrogen storage device 7. This may be taken into account in similar fashion using inequality secondary constraints, in which there is a requirement for the filling degree of the hydrogen storage device 7 never to become less than the minimum filling degree and never to become greater than the maximum filling degree.

Furthermore, the control device 8, when varying the sub-operating modes B1, B4, B6, B7, preferably also takes into account an average state of charge of the electrical energy storage device 6 and/or an average fill level of the hydrogen storage device 7. In both cases, this may be taken into account in that deviations from the average state of charge or the average fill level are incorporated into the cost function K in a manner weighted with—albeit relatively small—factors, and are thus “penalized”.

When varying the operating modes AB, SB, the control device 10 may additionally also take other conditions into account. Examples of such conditions may be for example specifications for the expected final substates Z1′, Z4′, Z6′, Z7′. There may also be a requirement for no energy to be fed into the supply grid 5 or for the energy drawn from the supply grid 5 not to exceed a specified maximum value. By way of example, it is possible to define, as a specification, that the electrical energy storage device 6 has a quite specific state of charge at the end of the forecast horizon PH or the state of charge of the electrical energy storage device 6 lies in a predetermined range at the end of the forecast horizon PH. Similar specifications are also possible for the other subsystems 1, 4 and 7. Such conditions may be taken into account in particular using what are known as equality secondary constraints and/or inequality secondary constraints. By way of example, there may be a requirement, as an equality secondary constraint, for the electrical energy storage device 6 and/or the hydrogen storage device 7 to have certain states of charge or fill levels at the end of the forecast horizon PH. Other conditions are also possible, for example for no energy to be fed into the supply grid 2, for the energy drawn from the supply grid 2 not to exceed a specified maximum value, or for the production of certain products to be complete at a specified time.

Optimization problems per se, their approach and procedures for solving such optimization problems are well known to those skilled in the art. They are also tackled in this way in terms of approach in the abovementioned prior art.

When step S7 is carried out, the varied and thereby optimized sub-operating modes B1, B4, B6, B7 are defined. The control device 8 may therefore, in a step S8, operate the subsystems 1, 4, 6, 7 in line with the varied sub-operating modes B1, B4, B6, B7. This is initially done for the beginning of the forecast horizon PH.

In a step S9, the control device 8 checks whether new information is available thereto. If this is not the case, the control device 8 returns to step S8. When carrying out step S8 again, the control device 8 continues to operate the subsystems 1, 4, 6, 7 in line with the varied sub-operating modes B1, B4, B6, B7. In so doing, it takes into account the progress of time t.

If new information is available to the control device 8, the control device 8 moves to a step 510. In step 510, the control device 8 checks whether the information is a command to stop the operation of the overall system. If this is the case, the control device 8 stops the operation of the overall system in a step S11. Otherwise, the control device 8 returns to step S1. Depending on the type of new information, the control device 8 may alternatively also return to step S2 or to step S3.

As a result, the procedure according to FIG. 2 means that the sub-operating modes B1, B4, B6, B7 continue to be ascertained repeatedly with a certain forecast horizon PH. The ascertainment is thus carried out in the sense of a permanent forecast and is adapted continuously to the expected price P and the production plan PP.

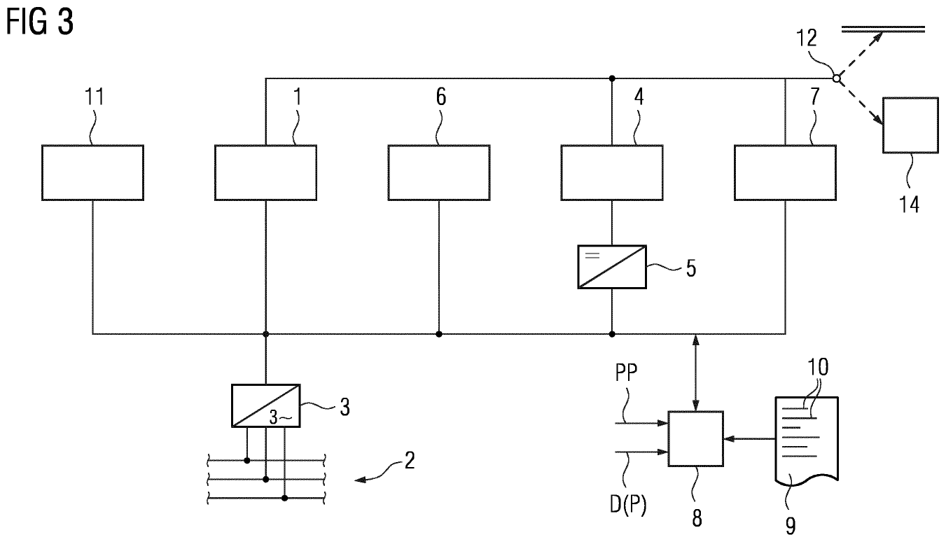

FIG. 3 shows an extension of the overall system from FIG. 1. In accordance with FIG. 3, the overall system has a power generation device 11 as a further subsystem. The power generation device 11 may be used to generate electrical energy renewably, that is to say using sunlight or wind power, possibly also using hydropower or geothermal energy. In this case, the power generation device 11 is connected directly or indirectly to the other electrical energy-receiving or outputting subsystems 1, 4, 6, and also to the electrical supply grid 2, in order to transmit electrical energy. A power converter, which is usually required for the power generation device 11, may be considered to be part of the power generation device 11. This is not also illustrated in FIG. 3. Preferably, it is possible to supply electrical energy from the power generation device 11 to the subsystems 1, 4, 6 without a diversion via the supply grid 2.

In accordance with FIG. 3, the overall system furthermore has a coupling device 12 as a further subsystem. The coupling device 12 is, on the one hand, connected directly or indirectly to the installation 1 and/or the electrolysis installation 4 and/or the hydrogen storage device 7 in order to transfer hydrogen. On the other hand, the coupling device 12 is connected to an external hydrogen transport network 13 or to an additional hydrogen storage device 14. In this case, the additional storage device 14 is connected detachably to the coupling device 12.

FIG. 3 shows an embodiment in which both the power generation device 11 and the coupling device 12 are present. However, it is also possible for only the power generation device 11 to be present or only the coupling device 12 to be present.

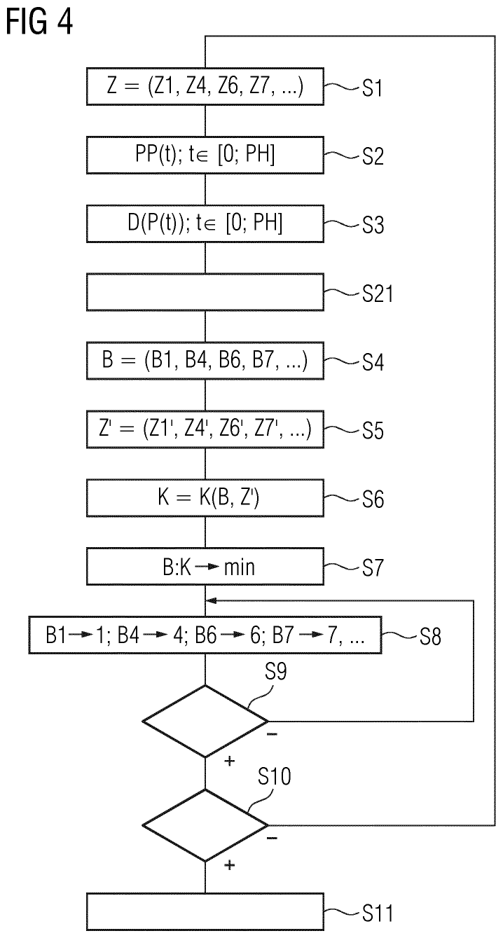

If the power generation device 11 is present, the procedure of FIG. 2 in accordance with FIG. 4 is initially modified such that a step S21 is additionally present. Step S21 precedes step S4. It may be preceded directly by step S4. However, this is not absolutely necessary. In step S21, the control device 8 is made aware, for the forecast horizon PH, of an amount of electrical energy that is (provisionally) able to be generated by the power generation device 11. Such a forecast may for example be made by utilizing a local weather forecast for the location of the power generation device 11.

Furthermore, the procedure of FIG. 2 is modified such that, in step S6, the expected electrical energy able to be generated by the power generation device 11 is taken into account in the cost function K. This gives rise, in step S7, to other sub-operating modes B1, B4, B6, B7 for which the cost function K becomes minimal.

If the coupling device 12 is present, the procedure of FIG. 2 is initially modified such that hydrogen storage device operating mode B7, which is set in step S4, is now a free variable, that is to say is no longer defined by installation operating mode B1 and electrolysis operating mode B4. On the contrary, hydrogen may also be taken from the transport network 13 or the additional storage device 14 or supplied to the transport network 13 or to the additional storage device 14. In this case, the cost function K is enhanced by a cost factor for the removal of hydrogen from the transport network 13 or from the additional storage device 14 or the feeding of hydrogen into the transport network 13 or into the additional storage device 14. As a result, the control device 8 thus also takes into account the hydrogen transferred via the coupling device 12 when varying the sub-operating modes B1, B4, B6, B7 in step S7.

FIG. 5 shows, purely by way of example, one possible design of an installation 1, that is to say of a steel industry installation.

In accordance with FIG. 5, the installation 1 has a direct reduction installation 15 as a component. In the direct reduction installation 15, sponge iron is produced from iron ore. The direct reduction installation 15 requires a constant supply of hydrogen and electrical energy in accordance with the production.

In accordance with FIG. 5, the installation 1 has an electric arc furnace 16 as a further component. By way of example, the iron sponge produced in the direct reduction installation 15, inter alia, may be supplied to the electric arc furnace 16 as an input product. The electric arc furnace 16 produces liquid steel. The energy requirement of the electric arc furnace 16 may be varied over time within certain limits. By way of example, it is possible to increase or reduce the required electrical energy in the minute range.

The installation 1 may furthermore have a ladle installation 17 as a further component. The liquid steel is handled in the ladle installation 17. By way of example, alloying elements may be added on a targeted basis and/or interfering elements may be removed, for example by vacuum treatment.

In accordance with FIG. 5, the installation 1 has a continuous casting installation 18 as a further component. The liquid steel is cast into a strand by the continuous casting installation 18.

The cast strand is often cut into individual slabs at the end of the continuous casting installation 18.

The slabs are further processed to form heavy plate or a strip in a rolling mill 19. A forecast for the electrical energy requirement of the rolling mill 19 may be ascertained based on the production plan PP. As a result of the production plan PP, inter alia, scheduled downtimes of the rolling mill 19 and starting products to be produced are known a few hours in advance, since slabs often have to lie for several hours in a furnace assigned to the rolling mill 19 in order to be heated or to homogenize temperatures before they are able to be rolled.

The other subsystems 4, 6 and 7 of the overall system are not also illustrated in FIG. 5. However, they are present as part of the overall system. The power generation device 11 and the coupling device 12 may possibly also be present. Furthermore, the installation 1 does not have to have all of the components 15 to 19 illustrated in FIG. 5.

An explanation is given below, for the components 15 to 19 of the installation 1 in accordance with FIG. 5, the electrolysis installation 4 (including the hydrogen storage device 7) and the power generation device 11, of possible models that may be used to ascertain the respective cost factor. These models are implemented within the control device 8 and are evaluated by the control device 8 as part of step S6.

For the rolling mill 19, it may be the case that there is no possibility of intervention there. In this case, the corresponding cost share K19 is a constant. In other cases, it is possible to adjust production, for example through (minor) stretching of an order block. Orders are therefore executed slightly more slowly. In this case, the cost share K19 brought about by the rolling mill 19 may be ascertained according to the relationship

$$K 19 = k 1 + k 2 T 19 \qquad ( 1 )$$

k1 is a constant with the unit “currency”, for example 2000 euros. k2 is a constant with the unit “currency per time”, for example 1000 euros per minute. T19 is the time difference by which the production of the rolling mill 19 is delayed, for example in minutes.

The costs of the energy required to operate the rolling mill 19, on the other hand, are negligibly small. It is therefore generally not necessary to use a more detailed model to model the rolling mill 19 in the course of step S6.

The rolling mill 19, with an upstream slab store, also has a sufficiently large storage device, and so the rolling mill 19 may be considered to be decoupled from the other components 15 to 18 of the installation 1. If necessary, a separate electrical energy storage device may be assigned to the rolling mill 19. In this case, the operation of the rolling mill 19 and the operation of the separate electrical energy storage device may be coordinated.

For the electric arc furnace 16, a function v and an electrical setpoint power P16* are set, each for the forecast horizon PH. The function v is a function of time t. The setpoint power P* may be a constant. The setpoint power P16* is multiplied by the function v. The result is the actual electric power P16 with which the electric arc furnace 16 is operated:

$$P 16 = v ( t ) P 16 * . \qquad ( 2 )$$

The function v is defined for positive values of time t and has a value range from vmin to 1, wherein vmin itself has a value between 0 and 1. vmin is a function of the state of the electric arc furnace 16. The current value of vmin takes into account the fact that it is not possible to arbitrarily reduce the actual power P16 in any state of the electric arc furnace 16. On the contrary, this depends on the state of the electric arc furnace 16. The control device 8 therefore has to be aware of the state of the electric arc furnace 16.

The total electrical energy requirement of the electric arc furnace 16 is a function of the profile of the function v. It is possible for the control device 8 to ascertain the total electrical energy requirement of the electric arc furnace 16 independently. As an alternative, the total electrical energy requirement of the electric arc furnace 16 may for example be specified or ascertained via the energy balance (radiation) of the electric arc furnace 16.

The function v may be used by the control device 8 to influence the operating mode of the electric arc furnace 16. Of course, the production of a batch is delayed if the function v has a value below 1. The control device 8 may therefore—in the same way as the procedure in the case of the rolling mill 19—ascertain and accordingly assess an associated time delay T16:

$$K 16 a = k 3 + k 4 T 16 . \qquad ( 3 )$$

k3 is a constant with the unit “currency”, for example 2000 euros. k4 is a constant with the unit “currency per time”, for example 1000 euros per minute. T16 is the time difference by which the production of the electric arc furnace 16 is delayed, for example in minutes.

The cost factor K16a is however confronted by considerable savings potential in terms of energy costs, provided that it manages to shift a high consumption of electrical energy of the electric arc furnace 16 to times when the electrical energy drawn from the supply grid 2 is inexpensive. The advantages of the present invention come to the fore in particular in the case of the electric arc furnace 16, that is to say when the operation of the installation 1, the electrolysis installation 4, the electrical energy storage device 6 and the hydrogen storage device 7 are jointly optimized. The advantages may be even greater if power is also able to be generated independently by the power generation device 11.

It may be advantageous, for the electric arc furnace 16, to take into account other variables and constraints. In particular, it is often necessary to take into account the fact that the production of a batch must be completed at a certain time, because the batch must then—with or without prior handling in the ladle installation 17—be supplied to the continuous casting installation 18. However, there is considerable flexibility. This is because the time absolutely required to produce a batch in the electric arc furnace 16 is less than the time in which the batch is poured in the continuous casting installation 18. It is therefore possible to divide the operation of the electric arc furnace 16 into three phases. The first phase involves just waiting until the batch has started melting. In the second phase, the batch is actually melted. The third phase involves waiting in a kind of standby mode until the produced batch is able to be supplied to the continuous casting installation 18.

In the first phase, the function v generally has the value 0. In the second phase, the function v has values greater than 0, wherein the values will usually be close to 1. In the third phase, the function v likewise has values greater than 0, but the values are much smaller than in the second phase. Varying the length of the three phases and the profile of the function v in the second and third phase sets the electrical energy supplied to the electric arc furnace 16. In addition, only a simple heating model is also required, in which the temperature of the batch is calculated as a function of the supplied electric power P16, and heat losses are also taken into account.

The cost share K16b caused for the electric arc furnace 16 due to the supplied electrical energy may be ascertained by integrating the respective instantaneous costs over the production horizon PH. The instantaneous costs may be ascertained as

$$k 5 ( t ) P 16 ( t ) \qquad ( 4 )$$

In this case, k5 is a factor, dependent at least on the time t, which reflects the costs of drawing electrical energy from the supply grid 2.

In the same say, it may also be possible to ascertain a cost share K16c caused for the electric arc furnace 16 due to the supplied hydrogen.

The cost share K16, which is determined for the electric arc furnace 16 as a whole, is the sum of the two cost shares K16a and K16b and the three cost shares K16a, K16b and K16c, respectively.

It may also be possible, in some cases, to postpone the times at which the production of a batch must be completed within certain limits. In particular, the casting rate of the continuous casting installation 18 may be varied. However, it should be taken into account here that the casting rate may often only be changed to a small extent—at most 10%, often even significantly less than 10%—and even then not abruptly, but only slowly. Only relatively small postponements of the times are thus possible.

For the cost share K15 of the direct reduction installation 15, a similar approach may be taken as that explained for the electric arc furnace 16, that is to say a share K15a caused by the time extension of operation, a share K15b caused by the electrical energy supplied to the direct reduction installation 15, and a share K15c caused by the hydrogen supplied to the direct reduction installation 15. However, the direct reduction installation 15 is preferably operated as uniformly as possible. The assessment of a time extension of the operation of the direct reduction installation 15 will therefore be significantly higher than the assessment of a time extension of the operation of the electric arc furnace 16. Also, the value corresponding to vmin will be higher, usually just below 1. Furthermore, direct reduction also produces carbon dioxide, for which certificates are often required when it is released into the environment. These costs also have to be taken into account.

For the cost share K17 of the ladle installation 17, a similar approach may be taken as that explained for the electric arc furnace 16, that is to say a share K17a caused by the time extension of operation, a share K17b caused by the electrical energy supplied to the ladle installation 17, and a share K17c caused by the hydrogen supplied to the ladle installation 17.

The continuous casting installation 18 incurs only relatively low energy costs. In particular, the continuous casting installation 18 requires no hydrogen, and requires electrical energy only to a comparatively small extent. As an alternative, it is possible to set the corresponding cost share K18 as a constant or—in the same way as the procedure in the case of the rolling mill 19—to additionally take into account a cost share that takes into account a (minor) reduction in casting rate and a resulting lower productivity.

The cost share K1 for the installation 1 is the sum of the contributions of the individual components of the installation 1.

The electrolysis installation 4 produces hydrogen and outputs it, and the hydrogen storage device 7 receives hydrogen and outputs it. It should be taken into account that stored hydrogen partially escapes. As already mentioned, the losses may be up to 0.5% of the stored amount of hydrogen per day. Furthermore, energy is needed to compress the hydrogen under pressure into the hydrogen storage device 7. This energy is usually no longer able to be recovered when the hydrogen is removed from the hydrogen storage device 7. The—common—costs K47 for the operation of the electrolysis installation 4 and of the hydrogen storage device 7 may be ascertained for example by integrating the respective instantaneous costs over the production horizon PH. The instantaneous costs may be ascertained as

$$k 5 ( t ) P 47 ( t ) + {k 6 H}^{′} ( t ) \qquad ( 5 )$$

In this case, k5 is the factor already explained in conjunction with Equation 4. P47 is the electrical energy drawn from the supply grid 2. In the simplest case, the factor k6 is a constant. The factor k6 may also be time-dependent where applicable. H′ is the amount of hydrogen that is currently being lost, that is to say the derivative of the amount of stored hydrogen as a function of time. If necessary, the wear of the electrolysis installation 4 may also be taken into account as well in the costs K47.

If the power generation device 11 is assigned directly to the other subsystems 1, 4, 6 and 7, that is to say in particular the electrical energy generated by the power generation device 11 is able to be supplied to the subsystems 1, 4, 6 and 7 without a diversion via the supply grid 2, the generation of the electrical energy is free of charge. If it (temporarily) exceeds the electrical energy consumption of the other subsystems 1, 4, 6 and 7, the electrical energy is fed into the supply grid 2. In this case, the costs K11 of the power generation device 11 may even be negative.

The price P of the electrical energy drawn from the supply grid 2 often depends not only on the time t, but also on the power drawn in each case. In this case, the energy consumptions of the various installation parts 15 to 19, that is to say the energy consumption of the installation 1 as a whole, together with the energy consumption of the electrolysis installation 4 and of the hydrogen storage device 7, and also the energy balance of the electrical energy storage device 6 and, where applicable, also the power generation by the power generation device 11, should be combined before the costs of drawing the electrical energy from the supply grid 2 are ascertained by exploiting the factor k5(t).

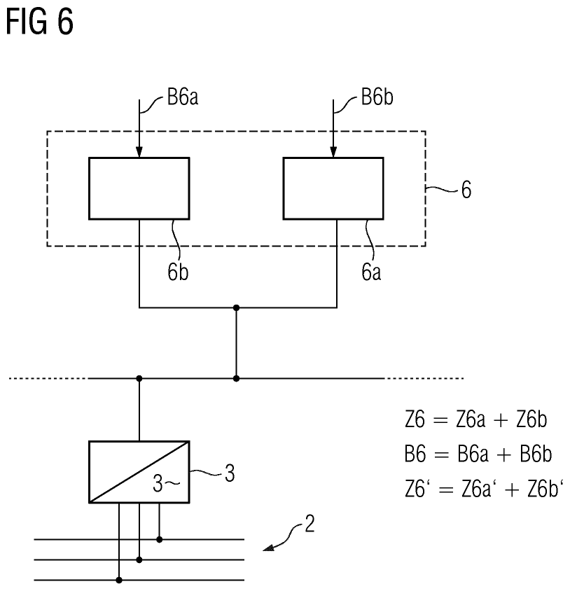

In accordance with FIG. 6, the electrical energy storage device 6 comprises a first partial storage device 6a and a second partial storage device 6b. The two partial storage devices 6a, 6b are both connected to the electrical supply grid 2. Accordingly, the current energy storage device state Z6 comprises a respective current substate Z6a, Z6b for the first and second partial storage device 6a, 6b. The same applies to energy storage device operating mode B6, which comprises a respective sub-operating mode B6a, B6b for the first and second partial storage device 6a, 6b. The expected final energy storage device state Z6′ therefore accordingly also comprises a respective expected final substate Z6a′, Z6b′ for the first and second partial storage device 6a, 6b. Of course, the control device 10, in varying energy storage device operating mode B6, varies the two sub-operating modes B6a, B6b and, based thereon, also varies the two expected final substates Z6a′, Z6b′. Furthermore, the control device 10 operates the first and second partial storage device 6a, 6b in line with the respective varied sub-operating mode B6a, B6b, at least for the beginning of the forecast horizon PH.

The present invention has many advantages. In particular, comprehensive optimization of the operation of the overall system consisting of the subsystems 1, 4, 6 and 7, and possibly additionally also the subsystems 11 and 12, is possible.

Although the invention has been illustrated and described more particularly by the preferred exemplary embodiments, the invention is not limited by the examples disclosed and other variations may be derived therefrom by a person skilled in the art without departing from the scope of protection of the invention.

List of reference signs

| | |
|---|---|
| 1 | Installation |
| 2 | Supply grid |
| 3 | Power converter |
| 4 | Electrolysis installation |
| 5 | Rectifier |
| 6 | Energy storage device |
| 6a, 6b | Partial storage device |
| 7 | Hydrogen storage device |
| 8 | Control device |
| 9 | Control program |
| 10 | Machine code |
| 11 | Power generation device |
| 12 | Coupling device |
| 13 | Transport network |
| 14 | Additional storage device |
| 15 | Direct reduction installation |
| 16 | Electric arc furnace |
| 17 | Ladle installation |
| 18 | Continuous casting installation |
| 19 | Rolling mill |
| B, B1, B4, B6, B7 | Operating modes |
| B6a, B6b | Sub-operating modes |
| D | Data |
| K | Cost function |
| P | Price |
| PH | Forecast horizon |
| PP | Production plan |
| S1 to S11 | Steps |
| Z, Z1, Z4, Z6, Z7 | Current states |
| Z′, Z1′, Z4′, Z6′, | Expected final states |
| Z7′ | |
| Z6a, Z6b | Current substates |
| Z6a′, Z6b′ | Expected final substates |

1. An operating method for an overall system,
wherein the overall system comprises, as subsystems, a steel industry installation, an electrolysis installation, an electrical energy storage device and a hydrogen storage device,
wherein the steel industry installation, the electrolysis installation and the electrical energy storage device are connected directly or indirectly to one another and to an electrical supply grid in order to transmit electrical energy,
wherein the steel industry installation, the electrolysis installation and the hydrogen storage device are connected directly or indirectly to one another in order to transfer hydrogen,
wherein a control device that controls the overall system is aware, as current states (Z1, Z4, Z6, Z7), of a current installation state (Z1) of the steel industry installation, a current electrolysis state (Z4) of the electrolysis installation, a current energy storage device state (Z6) of the energy storage device and a current hydrogen storage device state (Z7) of the hydrogen storage device,
wherein the control device is aware, for a forecast horizon (PH), of at least one desired production plan (PP) of the steel industry installation and at least one expected price (P) of electrical energy drawn from the supply grid,
wherein the production plan (PP) of the steel industry installation defines which end products are intended to be produced from which starting materials by the steel industry installation and which characteristics the end products are intended to have,
wherein the control device sets operating modes (B1, B4, B6, B7) for the forecast horizon (PH) and ascertains expected final states (Z1′, Z4′, Z6′, Z7′) for the end of the forecast horizon (PH),
wherein the operating modes (B1, B4, B6, B7) comprise an installation operating mode (B1) for the steel industry installation, an electrolysis operating mode (B4) for the electrolysis installation, an energy storage device operating mode (B6) for the electrical energy storage device and a hydrogen storage device operating mode (B7) for the hydrogen storage device,
wherein the expected final states (Z1′, Z4′, Z6′, Z7′) comprise a final installation state (Z1′) ascertained by exploiting the current installation state (Z1) and the set installation operating mode (B1), an expected final electrolysis state (Z4′) ascertained by exploiting the current electrolysis state (Z4) and the set electrolysis operating mode (B4), an expected final energy storage device state (Z6′) ascertained by exploiting the current energy storage device state (Z6) and the set energy storage device operating mode (B6), and an expected final hydrogen storage device state (Z7′) ascertained by exploiting the current hydrogen storage device state (Z7) and the set hydrogen storage device operating mode (B7),
wherein the current and final installation state (Z1, Z1′) comprise which materials are in which state in each case in the steel industry installation and the state of units of the steel industry installation,
wherein the control device varies the set operating modes (B1, B4, B6, B7) and, based thereon, the expected final states (Z1′, Z4′, Z6′, Z7′) for the forecast horizon (PH), taking into account the production plan (PP) and design limits of the subsystems, so as to minimize a cost function (K),
wherein the cost function (K) incorporates the costs of drawing electrical energy from the supply grid, the operating modes (B1, B4, B6, B7) of the steel industry installation, of the electrolysis installation, of the electrical energy storage device and of the hydrogen storage device, assessments of the expected final states (Z1′, Z4′, Z6′, Z7′) and a productivity of the steel industry installation, and
wherein the control device operates the subsystems in line with the varied operating mode (B1, B4, B6, B7), at least for the beginning of the forecast horizon (PH).

2. The operating method as claimed in claim 1, wherein the steel industry installation has at least one component technologically upstream of a casting device used to cast liquid steel.

3. The operating method as claimed in claim 1, wherein
the overall system has, as a further subsystem, a power generation device by way of which electrical energy is able to be generated renewably,
the power generation device is connected directly or indirectly to the steel industry installation, the electrolysis installation and the electrical energy storage device and the electrical supply grid in order to transmit electrical energy,
the control device, for the forecast horizon (PH), is additionally aware of an expected electrical energy able to be generated by the power generation device, and
the control device takes into account the expected electrical energy able to be generated by the power generation device when varying the operating modes (B1, B4, B6, B7).

4. The operating method as claimed in claim 1, wherein
the overall system has, as a further subsystem, a coupling device that is connected directly or indirectly to the steel industry installation and/or the electrolysis installation and/or the hydrogen storage device, on the one hand, and is connected to an external hydrogen transport network or to an additional hydrogen storage device, which is connected detachably to the coupling device, on the other hand, in order to transfer hydrogen,
the control device takes into account the hydrogen transferred via the coupling device when varying the operating modes (B1, B4, B6, B7), and
in that the cost function (K) incorporates the costs of the hydrogen transferred via the coupling device.

5. The operating method as claimed in claim 1, wherein
the cost function (K) incorporates losses of hydrogen contained in the hydrogen storage device.

6. The operating method as claimed in claim 1, wherein
the control device takes into account a minimum and maximum state of charge of the electrical energy storage device and/or an average state of charge of the electrical energy storage device and/or a minimum and maximum fill level of the hydrogen storage device and/or an average fill level of the hydrogen storage device when varying the operating modes (B1, B4, B6, B7).

7. The operating method as claimed in claim 1, wherein
the electrical energy storage device comprises a first partial storage device and a second partial storage device, both of which are connected to the electrical supply grid,
the current energy storage device state (Z6) comprises a respective current substate (Z6a, Z6b) for the first and second partial storage device,
the energy storage device operating mode (B6) comprises a respective sub-operating mode (B6a, B6b) for the first and second partial storage device,
the expected final energy storage device state (Z6′) comprises a respective expected final substate (Z6a′, Z6b′) for the first and second partial storage device,
when the energy storage device operating mode (B6) is varied, the two sub-operating modes (B6a, B6b) are varied and, based thereon, the two expected final substates (Z6a′, Z6b′) are varied, and
the control device operates the first and second partial storage device in line with the respective varied sub-operating mode (B6a, B6b), at least for the beginning of the forecast horizon (PH).

8. A control program for a control device for an overall system,
wherein the overall system comprises, as subsystems, a steel industry installation, an electrolysis installation, a hydrogen storage device and an electrical energy storage device,
wherein the steel industry installation, the electrolysis installation and the electrical energy storage device are connected directly or indirectly to one another and to an electrical supply grid in order to transmit electrical energy,
wherein the steel industry installation, the electrolysis installation and the hydrogen storage device are connected directly or indirectly to one another in order to transfer hydrogen,
wherein the control program comprises machine code-able to be executed by the control device,
wherein the execution of the machine code by the control device causes the control device to control the overall system in line with an operating method as claimed in claim 1.

9. A control device for an overall system,
wherein the overall system comprises, as subsystems, a steel industry installation, an electrolysis installation, a hydrogen storage device and an electrical energy storage device,
wherein the steel industry installation, the electrolysis installation and the electrical energy storage device are connected directly or indirectly to one another and to an electrical supply grid in order to transmit electrical energy,
wherein the steel industry installation, the electrolysis installation and the hydrogen storage device are connected directly or indirectly to one another in order to transfer hydrogen,
wherein the control device is programmed, by way of a control program, such that the control device, when the machine code of the control program is executed, controls the overall system in line with an operating method as claimed in claim 1.

10. An overall system,
wherein the overall system comprises, as subsystems, a steel industry installation, an electrolysis installation, a hydrogen storage device and an electrical energy storage device,
wherein the steel industry installation, the electrolysis installation and the electrical energy storage device are connected directly or indirectly to one another and to an electrical supply grid in order to transmit electrical energy,
wherein the steel industry installation, the electrolysis installation and the hydrogen storage device are connected directly or indirectly to one another in order to transfer hydrogen,
wherein the overall system comprises a control device that controls the overall system in line with an operating method as claimed in claim 1.
